(19) United States
(12) Patent Application Publication
(10) Pub. No.: US 2006/0291100 A1
(43) Pub. Date: Dec. 28, 2006

(54) Thin film structure having a soft magnetic interlayer

(75) Inventors: Bin Lu, Pittsburgh, PA (US); Timothy Klemmer, Pittsburgh, PA (US); Dieter Weller, Gibsonia, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/159,500

(22) Filed: Jun. 23, 2005

(51) Int. Cl. G11B 5/127; G11B 5/82

(52) U.S. Cl. 360/135

(57) ABSTRACT

A thin film structure that includes a hard magnetic recording layer, a soft magnetic underlayer and an intermediate layer between the hard magnetic recording layer and the soft magnetic underlayer is disclosed. The intermediate layer comprises a soft magnetic interlayer, and a non-magnetic interlayer between the soft magnetic interlayer and the hard magnetic recording layer. The thin film structure can be a recording medium. The soft magnetic interlayer can be crystalline.

### FIELD OF THE INVENTION

The invention relates to thin film structures, and, more particularly, relates to thin film structures having a soft magnetic interlayer.

### BACKGROUND INFORMATION

Thin films of various types and configurations are generally known. One particular thin film application is for a data storage component, such as a recording media. For a specific type of media for perpendicular recording, it is known to include a magnetic soft underlayer and a magnetic recording layer. In such a structure, an interlayer may be provided therebetween to control the orientation and size of magnetic grains in the magnetic recording layer. Presently known interlayers have considerable thickness in order to achieve acceptable microstructure in the magnetic recording layer. When the thickness of a conventional interlayer is reduced, the thin film structure typically exhibits exchange-coupled grains in the magnetic recording layer, which render poor magnetic properties and recording performance. To achieve higher areal densities using perpendicular recording, so as to realize the benefits of the writeability of the soft underlayer and enhanced head field gradient, the interlayer thickness should be reduced.

Accordingly, there is identified, a need for improved thin film structures that overcome the limitations, disadvantages, or shortcomings of known thin film structures. There is also identified a need for improved recording media that overcome the limitations, disadvantages, or shortcomings of known recording media. There is further identified a need for improved recording media that improves the microstructure in the magnetic recording layer and reduces the thickness of a conventional interlayer.

### SUMMARY OF THE INVENTION

The invention meets the identified need, as well as other needs, as will be more fully understood following a review of this specification and drawings.

In accordance with an aspect of the invention, a thin film structure comprises a first soft magnetic layer, a hard magnetic layer, and an intermediate layer between the first soft magnetic layer and the hard magnetic layer. The intermediate layer comprises a second soft magnetic layer and a non-magnetic interlayer between the second soft magnetic layer and the hard magnetic layer. The second soft magnetic layer may be crystalline. More particularly, the second soft magnetic layer may have fcc or bcc crystalline structure.

In accordance with another aspect of the invention, a recording medium comprises a soft magnetic underlayer, a recording layer, a non-magnetic interlayer between the soft magnetic underlayer and the recording layer, and a soft magnetic interlayer between the non-magnetic interlayer and the soft magnetic underlayer. The recording layer may be a perpendicular magnetic recording layer.

In accordance with yet another aspect of the invention, a data storage system comprises a magnetic recording head, and a recording medium positioned adjacent the recording head. The recording medium comprises a soft magnetic underlayer, a recording layer, a non-magnetic interlayer between the soft magnetic underlayer and the recording layer, and a soft magnetic interlayer between the non-magnetic interlayer and the soft magnetic underlayer. The recording medium may be a perpendicular recording medium.

These and other aspects of the present invention will be more apparent from the following description.

### BRIEF DESCRIPTION OF THE DRAWINGS

FIG. 1 is a pictorial representation of a data storage system that may utilize a perpendicular recording medium in accordance with the invention.

FIG. 2 is a partially schematic side view of a perpendicular magnetic recording head and a perpendicular recording magnetic medium in accordance with the invention.

FIG. 3 is a schematic side view of a perpendicular magnetic recording medium in accordance with the invention.

FIG. 4A is a schematic side view of a portion of a perpendicular magnetic recording head and a portion of a perpendicular recording magnetic medium

FIG. 4B is a schematic side view of a portion of a perpendicular magnetic recording head and a portion of a perpendicular recording magnetic medium in accordance with the invention.

FIG. 5 is a graph that illustrates the coercivity of the hard magnetic recording layer versus the thickness of the interlayer.

FIG. 6 is a graph that illustrates the coercivity of the hard magnetic recording layer versus the thickness of the interlayer.

FIG. 7 is a graph that illustrates a MOKE hysteresis loop for a magnetic recording medium constructed in accordance with the invention.

FIG. 8 is a graph that illustrates a perpendicular hysteresis loop for a thin film structure constructed in accordance with the invention.

FIG. 9 is a graph that illustrates a MOKE hysteresis loop for a thin film structure constructed in accordance with the invention.

### DETAILED DESCRIPTION

The invention provides a thin film structure. The invention is particularly suitable for use with a data storage system, and is particularly suitable for use with a perpendicular magnetic recording medium of a data storage system. However, it will be appreciated that the invention may also have other applications, such as, for example, magneto-optical recording, heat assisted magnetic recording, or other technologies that may utilize thin film structures.

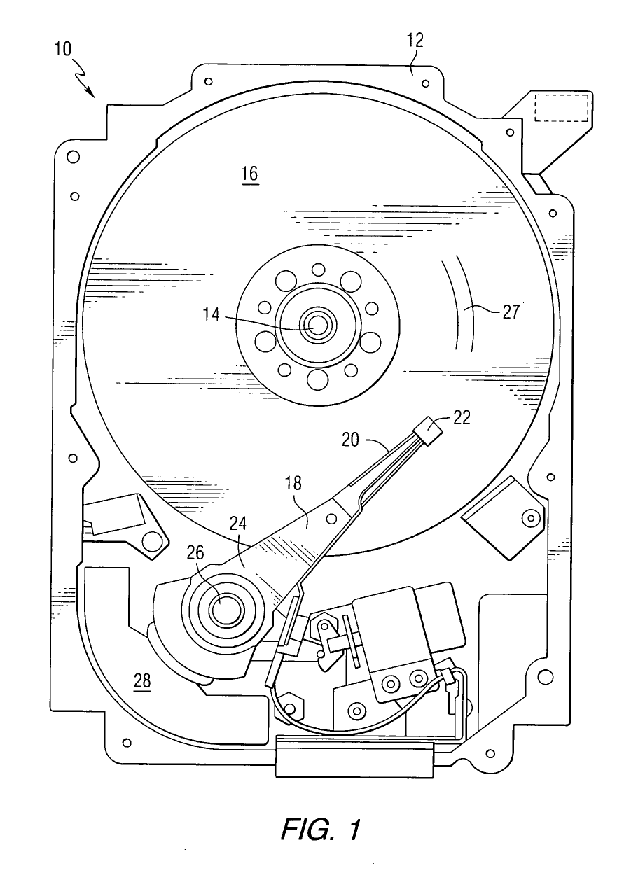

FIG. 1 is a pictorial representation of a disc drive 10 that can utilize a recording medium in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

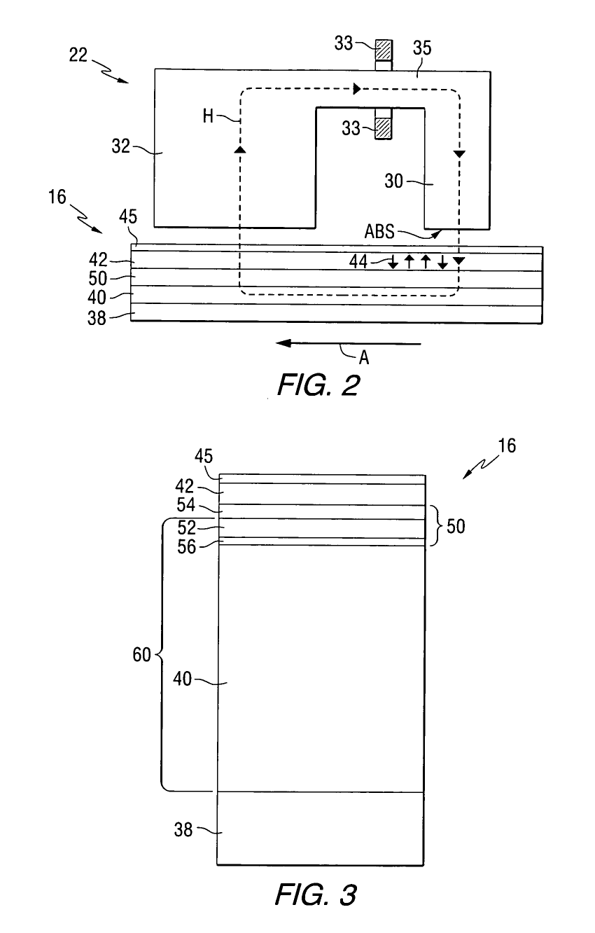

FIG. 2 is a partially schematic side view of a perpendicular magnetic recording head 22 and a thin film structure, such as a perpendicular recording magnetic medium 16. The recording head 22 is well known in the art and includes a write section comprising a trailing main pole 30 and a return or opposing pole 32. Flux (H) is directed from main pole 30 into the recording medium 16 and returned to the opposing pole 32. A magnetizing coil 33 surrounds a yoke 35, which connects the main pole 30 and return pole 32. The recording head 22 may also include a read section (not shown), as is generally known in the art. The read section may include, for example, a conventional giant magneto-resistance (GMR) reader, magnetic-resistance reader, inductive reader, magneto-optical reader, or the like as is also generally known in the art.

Still referring to FIG. 2, the perpendicular magnetic recording medium 16 is positioned under the recording head 22. The recording medium 16 travels in the direction of arrow A during recording. The recording medium 16 includes a substrate 38, which may be made of any suitable material such as ceramic glass, amorphous glass, or NiP plated AlMg. A first soft magnetic layer, such as a soft magnetic underlayer 40, is deposited on the substrate 38. The soft magnetic underlayer 40 may be made of any suitable material such as FeCoB, CoZrNb or NiFeNb. Typically, the soft magnetic underlayer 40 is amorphous. The soft magnetic underlayer 40 may have a thickness in the range of from about 50 nm to about 500 nm.

A hard magnetic recording layer 42, which in this embodiment is a perpendicular recording layer as illustrated by the perpendicular oriented magnetic domains 44, is deposited on an intermediate layer 50 that is deposited on the soft magnetic underlayer 40. Suitable materials for the hard magnetic recording layer 42 may include, for example, CoPtX and alloys thereof where X may be Cr, Ni, B, Si, C, Nb, Mo, Gr or combinations thereof, Co/Pd, Co/Pt, CoY/PdZ and CoY/PtZ multilayer systems, wherein Y and Z may be Cr, B, Si, Au, Ag and/or combinations of these elements. It will be appreciated that the recording layer 42 may be constructed in accordance with the invention to provide, for example, magnetic data storage capabilities or magneto-optical data storage capabilities. A protective overcoat 45, such as a diamond-like carbon and/or a lubricant layer may be applied over the hard magnetic recording layer 42 as is generally known.

Referring to FIG. 3, an embodiment of the recording medium 16 is illustrated in more detail and, more particularly, an embodiment of the intermediate layer 50 is shown in more detail. Specifically, the intermediate layer 50 includes a second soft magnetic layer, such as a soft magnetic interlayer 52, and a non-magnetic interlayer 54. Intermediate layer 50 can optionally comprise a seedlayer 56.

Still referring to FIG. 3, the soft magnetic interlayer 52 is a magnetically soft layer, however, the structure of the layer may be crystalline. The soft magnetic interlayer 52 can have preferred orientation or crystallographic texture, such as face-centered-cubic (fcc) crystalline structure having a (111) orientation and/or body-centered-cubic (bcc) crystalline structure having a (110) orientation. The soft magnetic interlayer 52 may be formed of any crystalline soft magnetic materials, such as Co, Fe, Ni and/or combination and/or alloys thereof, such as NiFe, FeCo or CoNi. The soft magnetic interlayer 52 may have a thickness of from about 1 nm to about 50 nm. The soft magnetic interlayer 52 can be deposited directly on the soft magnetic underlayer 40, or can be deposited on a seedlayer 56 which can be deposited directly on the soft magnetic underlayer 40.

The seedlayer 56 may comprise any suitable material such as Pt, Cu, Ag, Al and/or combinations thereof. The seedlayer 56 can be deposited on the soft magnetic underlayer 40 to any desired thickness, such as a thickness of from about 1 nm to about 10 nm. In one example, the seedlayer 56 may comprise a material having an fcc crystalline structure having a (111) orientation. Such a seedlayer 56 can provide a compatible starting orientation for a soft magnetic interlayer 52 comprising either an fcc material having a (111) orientation or a bcc material having a (110) orientation in which hetero-epitaxy growth can occur between the seedlayer 56 and the soft magnetic interlayer 52.

The non-magnetic interlayer 54 can be deposited on the soft magnetic interlayer 52. The non-magnetic interlayer 54 can be deposited to a thickness of from about 1 nm to about 20 nm. The non-magnetic interlayer 54 can comprise a crystalline non-magnetic material, such as Pt, Cu, Ag, Au, Al, CoCrRu, Ru, CoRu, CrRu, Re, CoRe, CrRe, ReRu, Co, Cr, Re and/or alloys and/or combinations thereof. The non-magnetic interlayer 54 can comprise more than one crystalline non-magnetic material, such as a layer of CoCrRu and a layer of Ru. Such a non-magnetic interlayer 54 can be used in a recording medium 16 with a hard magnetic recording layer 42 comprising CoPtX or CoPtX alloys having hexagonally close packed (hcp) crystalline structure. As the non-magnetic interlayer 54 is epitaxially grown on the soft magnetic interlayer 52, the hexagonally close packed (hcp) structured grains of the non-magnetic interlayer 54 can grow in the (00.2) orientation on top of the (111) oriented grains for an fcc structure or (110) oriented grains for a bcc structure of the soft magnetic interlayer 52. Accordingly, the non-magnetic interlayer 54 can provide a (00.2) oriented surface on which the hard magnetic recording layer 42 can be deposited.

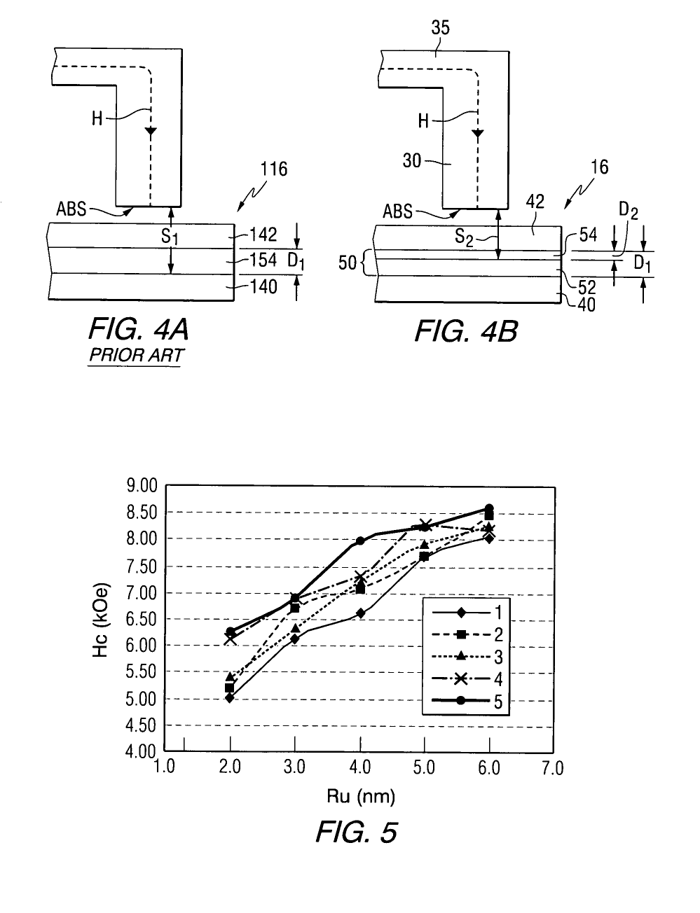

The thickness of the intermediate layer 50, comprising the soft magnetic interlayer 52, the non-magnetic interlayer 54 and optionally the seedlayer 56, can be comparable to the thickness of a conventional non-magnetic interlayer. Referring to FIGS. 4A and 4B, in the design of a perpendicular magnetic recording system, it is important to minimize the spacing (S) between an air-bearing surface (ABS) of the recording head and the soft magnetic portion of the recording medium 116 and 16 in order to obtain maximum writing field strength and high head field gradient. The soft magnetic portion of a conventional recording medium 116, shown in FIG. 4A, comprises the soft magnetic underlayer 140. As shown in FIGS. 3 and 4B, the soft magnetic portion 60 of a recording medium in accordance with the invention comprises the soft magnetic underlayer 40, the soft magnetic interlayer 52 and optionally a seedlayer 56. In order to minimize the spacing (S), it is important to reduce the non-magnetic portion of the recording medium 16 by utilizing a non-magnetic interlayer 54 that is as thin as possible.

FIG. 4A illustrates the spacing (S₁) between the ABS and the soft magnetic underlayer 40 of a thin film structure when a hard magnetic recording layer 142 and a conventional non-magnetic interlayer 154 are present. FIG. 4B illustrates that the spacing (S₂) between the ABS and the soft magnetic interlayer 52, in accordance with the invention, is thinner than the conventional spacing (S₁) shown in FIG. 4A. As shown in FIG. 4B, spacing (S₂) is thinner than the spacing (S₁) because the soft magnetic interlayer 52 comprises part of the soft magnetic portion.

The soft magnetic interlayer 52, constructed in accordance with the invention, allows for the formation of the recording medium 16 and, more specifically, for the formation of a hard magnetic recording layer 42 having suitable properties for perpendicular magnetic recording such as improved grain distribution and controlled grain size. FIG. 4A shows a conventional recording medium 116 having a conventional non-magnetic interlayer 154 thickness (D₁). FIG. 4B shows a recording medium 16, in accordance with the invention, having a non-magnetic interlayer 54 having a thickness (D₂) that is thinner than the thickness (D₁). Although the intermediate layer 50 of the present invention has a comparable thickness to a conventional interlayer, the soft magnetic interlayer 52 causes the intermediate layer 50 of the present invention to function differently from a conventional interlayer. The soft magnetic interlayer 52 has features of both a conventional interlayer and a soft magnetic underlayer 40. The soft magnetic interlayer 52 is both crystalline, thereby controlling the microstructure of the hard magnetic recording layer 42, and magnetically soft, thereby acting as part of the soft magnetic underlayer 40.

As shown in FIG. 4B, the intermediate layer 50 of the present invention can have essentially the same thickness (D₁) as the thickness of the conventional non-magnetic interlayer 154 shown in FIG. 4A. Because the soft magnetic interlayer 52 of the present invention, shown in FIG. 4B, has magnetic properties, the thickness of the soft magnetic interlayer 52 does not contribute to the thickness of the non-magnetic portion of the intermediate layer 50. As a result, as shown in FIG. 4B, the real spacing (S₂) between the ABS and the soft magnetic underlayer 40 is reduced as compared to the spacing (S₁) of a conventional thin film having a conventional non-magnetic interlayer. The soft magnetic portion of the recording medium 16, according to the present invention, includes both the soft magnetic underlayer 40 and the soft magnetic interlayer 52. The non-magnetic portion of the intermediate layer 50 comprises the non-magnetic interlayer 54.

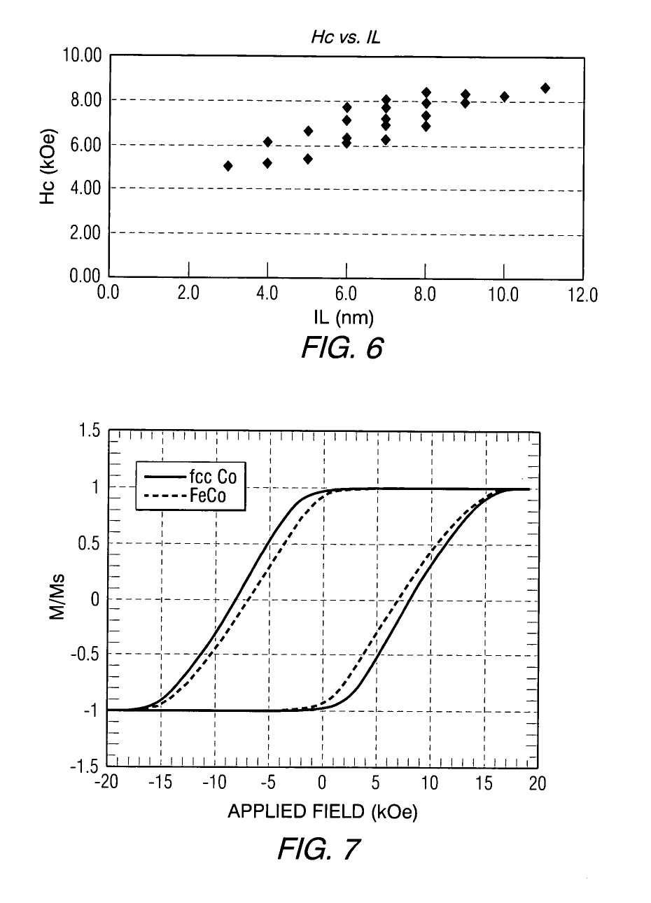

FIGS. 5 and 6 illustrate the coercivity (H_{c}) of a hard magnetic recording layer 42 of a recording medium 16 having a non-magnetic interlayer 54 comprising CoCrRu and Ru layers of varying thickness. More specifically, the recording medium 16 of FIGS. 5 and 6 is as follows: glass substrate 38, simulated soft magnetic underlayer comprising an amorphous Ta layer having a thickness of 2 nm, seedlayer 56 comprising Pt having a thickness of 3 nm, soft magnetic interlayer 52 comprising FeCo having a thickness of 10 nm, non-magnetic interlayer 54 comprising CoCrRu/Ru wherein the CoCrRu layer has a thickness of X nm and the Ru layer has a thickness of Y nm, hard magnetic recording layer 42 comprising CoPt and oxide having a thickness of 12 nm, and a protective overcoat 45 comprising a carbon overcoat having a thickness of 4.5 nm, wherein X is shown in the legend of FIG. 5 as the thickness of the CoCrRu layer, i.e., 1 equates to a CoCrRu layer of 1 nm, 2 equates to a CoCrRu layer of 2 nm, etc., and Y is shown along the X-axis of FIG. 5 as the thickness of the Ru layer.

As shown in FIG. 5, the coercivity H_{c} of the hard magnetic recording layer 40 varies with the thickness of the CoCrRu and Ru layers of the non-magnetic interlayer 54. As shown in FIG. 5, for each Ru layer thickness shown on the graph, the legend provides 5 corresponding CoCrRu layer thicknesses. The thicknesses of the Ru layer and the CoCrRu layer are combined to provide the total thickness of the non-magnetic interlayer 54.

As shown in FIG. 6, for each non-magnetic interlayer 54 thickness, several thickness combinations of the CoCrRu layer and the Ru layer are possible. Using the data from FIG. 5, FIG. 6 shows that for any non-magnetic interlayer 54 thickness, the thickness of the CoCrRu and Ru layers can be selected to maximize the coercivity of the hard magnetic recording layer 42. As shown in FIG. 6, a recording medium 16 with a non-magnetic interlayer 54 having a total thickness of 4 nm, comprising a 1 nm CoCrRu layer and a 3 nm Ru layer, can have a coercivity as high as 6 kOe in the hard magnetic recording layer 42. Such a coercivity value is very large and beyond the writeability of known recording heads. At such a thin non-magnetic interlayer 54, the recording medium 16 exhibits H_{c}=6.14 kOe, S=1, Hₙ=−1.57 kOe, and Alpha=2.1, where H_{c} is the coercivity, S is the squareness of the hysteresis loop, Hₙ is the nucleation field of the loop, and Alpha is 4πdM/dH where H=H_{c} is the slope of the loop at H=H_{c}.

FIG. 7 illustrates a normalized Magneto-Optical Kerr Effect (MOKE) hysteresis loop of a recording medium 16 having a soft magnetic interlayer 52 comprising fcc Co and a recording medium 16 having a soft magnetic interlayer comprising FeCo. The recording medium 16 structure of FIG. 7 is as follows: glass substrate 38, simulated soft magnetic underlayer comprising an amorphous Ta layer having a thickness of 2 nm, seedlayer 56 comprising Pt having a thickness of 3 nm, soft magnetic interlayer 52 comprising FeCo or fcc Co having a thickness of 10 nm, non-magnetic interlayer 54 comprising CoCrRu/Ru wherein the CoCrRu layer has a thickness of 5 nm and the Ru layer has a thickness of 7 nm, hard magnetic recording layer 42 comprising CoPt and oxide having a thickness of 12 nm, and a protective overcoat 45 comprising a carbon overcoat having a thickness of 4.5 nm.

As shown in FIG. 7, a recording medium 16 having a soft magnetic interlayer 52 comprising either Co or FeCo has high coercivity. However, a soft magnetic interlayer 52 comprising fcc Co has higher coercivity than a soft magnetic interlayer 52 comprising bcc FeCo, as determined by the amount of applied field along the X-axis measured from the 0 value of the M/Mₛ Y-axis. The orientation dispersion of the (00.2) axis of the CoPt alloy grains is about 5.3 degrees determined by a full width half maximum (FWHM) of an x-ray diffraction rocking curve of the (00.2) peak. The magnetic properties of the recording medium 16 having a soft magnetic interlayer 52 comprising fcc Co are H_{c}=8.11 kOe, S=0.97, Hₙ=2.22 kOe, and Alpha ˜1.6. The magnetic properties of the recording medium 16 having a soft magnetic interlayer 52 comprising FeCo are H_{c}=6.94 kOe, S=0.93, Hₙ=−0.41 kOe, and Alpha ˜1.44.

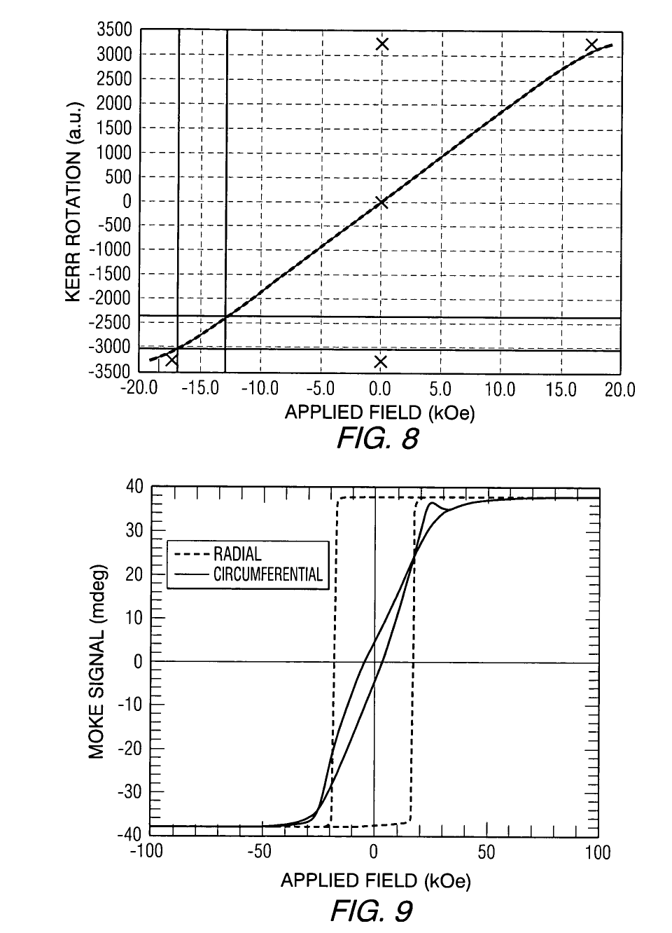

FIG. 8 illustrates a graph of a perpendicular hysteresis loop for a thin film structure having a soft magnetic interlayer 52 comprising fcc Co and having a thickness of 50 nm. The thin film structure of FIG. 8 is as follows: glass substrate 38, simulated soft magnetic underlayer comprising an amorphous Ta layer having a thickness of 2 nm, seedlayer 56 comprising Pt having a thickness of 3 nm, soft magnetic interlayer 52 comprising fcc Co having a thickness of 50 nm, and a protective overcoat 45 comprising a carbon overcoat having a thickness of 4.5 nm.

As shown in FIG. 8, the thin film is close to the saturation point at the highest field of the MOKE loop. It is estimated from the point at which the straight-line plot of Kerr rotation versus applied field begins to turn, that the saturation field is about 1.7T. This value is close to the 4πMₛ value of pure Co. Accordingly, FIG. 8 shows that the soft magnetic interlayer 52 has similar properties, including softness, to the amorphous soft magnetic underlayer 40.

FIG. 9 illustrates an in-plane MOKE hysteresis loop for the recording medium 16 structure of FIG. 8. As shown in FIG. 9, the thin film having a Co soft magnetic interlayer 52 has the magnetic easy axis aligned in the radial direction. The hysteresis loop in the radial direction is square and the coercivity is about 15 kOe. The hysteresis loop in the circumferential direction is a slanted line and the saturation field (Hₖ) is about 40 kOe. In-plane anisotropy is critical in the soft magnetic underlayer in perpendicular magnetic recording. FIG. 9 shows that the soft magnetic interlayer 52 has similar properties, including radial in-plane anisotropy, to the amorphous soft magnetic underlayer 40.

Whereas particular embodiments of the invention have been described herein for the purpose of illustrating the invention and not for the purpose of limiting the same, it will be appreciated by those of ordinary skill in the art that numerous variations of the details, materials, and arrangements of parts may be made within the principle and scope of the invention without departing from the invention as described herein and in the appended claims.

What is claimed is:

1. A thin film structure, comprising:
a first soft magnetic layer;
a hard magnetic layer; and
an intermediate layer between the first soft magnetic layer and the hard magnetic layer, the intermediate layer comprising:
a second soft magnetic layer; and
a non-magnetic interlayer between the second soft magnetic layer and the hard magnetic layer.

2. The thin film structure of claim 1, wherein the second soft magnetic layer is crystalline.

3. The thin film structure of claim 2, wherein the second soft magnetic layer has bcc or fcc crystalline structure.

4. The thin film structure of claim 1, wherein the second soft magnetic layer has a thickness in the range of from 1 nm to 50 nm.

5. The thin film structure of claim 1, further comprising a seedlayer between the first soft magnetic layer and the second soft magnetic layer.

6. The thin film structure of claim 1, wherein the seedlayer and the second soft magnetic layer each have fcc crystalline structure.

7. The thin film structure of claim 1, wherein the seedlayer has a thickness in the range of from 1 nm to 10 nm.

9. The thin film structure of claim 1, wherein the non-magnetic interlayer comprises more than one crystalline non-magnetic material.

10. The thin film structure of claim 1, wherein the non-magnetic interlayer has a thickness in the range of from 1 nm to 20 nm.

11. A recording medium, comprising:
a soft magnetic underlayer;
a recording layer;
a non-magnetic interlayer between the soft magnetic underlayer and the recording layer; and
a soft magnetic interlayer between the non-magnetic interlayer and the soft magnetic underlayer.

12. The recording medium of claim 11, wherein the soft magnetic interlayer is crystalline.

13. The recording medium of claim 11, wherein the recording layer is a perpendicular magnetic recording layer.

14. The recording medium of claim 11, wherein the soft magnetic interlayer has a thickness in the range of from 1 nm to 50 nm.

15. The recording medium of claim 11, wherein the non-magnetic interlayer has a thickness in the range of from 1 nm to 20 nm.

16. A data storage system, comprising:
a magnetic recording head; and
a recording medium positioned adjacent the recording head, the recording medium comprising:
a soft magnetic underlayer;
a recording layer;
a non-magnetic interlayer between the soft magnetic underlayer and the recording layer; and
a soft magnetic interlayer between the non-magnetic interlayer and the soft magnetic underlayer.

17. The data storage system of claim 16, wherein the recording layer is a perpendicular recording layer.

18. The data storage system of claim 16, wherein the soft magnetic interlayer is crystalline.

19. The data storage system of claim 16, wherein the soft magnetic interlayer has a thickness in the range of from 1 nm to 50 nm.

20. The recording medium of claim 16, wherein the non-magnetic interlayer has a thickness in the range of from 1 nm to 20 nm.
